(19) United States
(12) Patent Application Publication
(10) Pub. No.: US 2009/0272002 A1
(43) Pub. Date: Nov. 5, 2009

(54) WASHING MACHINE EQUIPPED WITH A RADIATION DRYING UNIT

(76) Inventors: Sun Hoo PARK, Seoul (KR); Kyung Hag Kim, Seoul (KR)

Correspondence Address: BACON & THOMAS, PLLC, 625 SLATERS LANE, FOURTH FLOOR, ALEXANDRIA, VA, 22314-1176, US

(21) Appl. No.: 12/503,469

(22) Filed: Jul. 15, 2009

Related U.S. Application Data
(63) Continuation of application No. 11/117,546, filed on Apr. 29, 2005.

(30) Foreign Application Priority Data
May 3, 2004 (KR) 10-2004-0031084
May 12, 2004 (KR) 10-2004-0033524

(51) Int. Cl. F26B 3/34

(52) U.S. Cl. 34/267

(57) ABSTRACT

A washing machine equipped with a radiation drying unit includes a rotary drum for accommodating laundry therein, a water tub for accommodating the rotary drum rotatably, a far infrared radiation generator for generating a radiant ray in a far infrared wavelength range, a radiation transmission portion for transmitting the radiant ray generated by the far infrared radiation generator to the rotary drum, a radiation controller for controlling an amount of the radiant ray transmitted from the far infrared radiation generator to the rotary drum, and a convection fan for circulating air by rotating in forward and reverse direction depending on an internal temperature of the rotary drum.

### FIELD OF THE INVENTION

The present invention relates to a washing machine equipped with a radiation drying unit; and, more particularly, to a washing machine capable of performing a drying operation by using far infrared radiation.

### FIELD OF THE INVENTION

In general, washing machines can be classified into two types: pulsator type and drum type.

With regard to a pulsator type washing machine, a washer tub for accommodating laundry therein and a water tub for accommodating the washer tub therein are vertically installed in the washing machine, and the washing of the laundry is done by using a friction of water currents generated as a result of rotating a pulsator disposed in a bottom portion of the washing machine.

In a drum type washing machine, on the other hand, a rotary drum for accommodating laundry therein and a water tub for accommodating the rotary drum therein are horizontally supported in the washing machine, and the washing of the laundry is performed through drop movements of the laundry.

Recently, the drum type washing machine is gaining popularity because it has many advantages compared to the pulsator type washing machine. For example, by configuring the washing machine as drum type, its capacitance can be maximized and the phenomenon of the laundry being entangled with each other after being washed can be reduced. With such an increasing demand for the drum type washing machine, relevant technologies for improving the usability of the drum type washing machine have been rapidly developed.

There are respectively shown in FIGS. 1 and 2 a perspective view and a cross sectional view of a conventional drum type washing machine.

As shown in FIG. 1, the conventional drum type washing machine includes a washing machine main body 10 having a laundry loading/unloading opening 1 at a front surface thereof, a water tub 2 installed in the washing machine main body 10, a driving motor 3 installed below the water tub 2, and a rotary drum 5 horizontally installed inside the water tub 2 such that it is rotated by the driving force of the driving motor 3. Further, a door 6 for opening or closing the laundry loading/unloading opening 1 is installed at the front surface of the washing machine main body 10. Also, installed in an upper portion of the washing machine main body 10 is a drying unit 20 for drying laundry by removing moisture contained in the interior air of the washing machine while circulating it. Moreover, the drum type washing machine further includes a belt mechanism 25 (see FIG. 2) for connecting the driving motor 3 and the rotary drum 5.

Referring to FIG. 2, the drying unit 20 has a fan 30 installed inside the washing machine main body 10, a heater 32 installed at one side of the fan 30, and an air flow duct 34 forming an air flow passage extended from the fan 30 to a front portion of the rotary drum 5 via the heater 32.

The drum type washing machine with the drying function configured as described above performs a washing operation by agitating the laundry vertically by way of rotating the rotary drum 5. After the completion of the washing operation, a water-extracting operation is performed by spinning the rotary drum 5 at a high rotational speed.

After the water-extracting operation, a drying operation for drying the laundry is performed by means of the drying unit 20. Specifically, the drying operation involves directing the air outside the water tub 2 to the heater 32 by rotating fan 30, heating the air by the heater 32 while the air flows through the heater 32 and then blowing the heated air into the rotary drum 5 which is slowly rotated.

During this drying operation, the moisture contained in the laundry evaporates by the high-temperature dry air blown into the rotary drum 5, and, as a result, the laundry is dried. Therefore, it becomes unnecessary to take out the laundry from the washing machine to dry it, so that the user's convenience can be improved.

However, in the above-described conventional drum type washing machine that performs the drying operation through the supply of the high-temperature dry air, the laundry may be damaged in case the temperature of the air is not controlled precisely. Further, even though the laundry is dried, there is likelihood that the laundry is infected or has an unpleasant odor because it contacts the high-temperature damp air during the drying process

In order to solve the problems, there is developed a washing machine using far infrared radiation for the drying operation (see, for example, Korean Patent No. 10-0329267), wherein a drying unit employed therein includes a heater 42 installed at a central portion of a rotary drum 40 and a heater protection member 44 for surrounding the heater 42, as illustrated in FIG. 3. Here, the heater 42 is a far infrared radiation heater.

In this washing machine, the drying operation is performed through a flow of hot air. Specifically, high-temperature dry air that has passed through the heater 42 is dispersed radially from the central portion of the rotary drum 40, thereby drying the laundry therein.

Since, however, the far infrared radiation heater is disposed at the central portion of the rotary drum in the conventional configuration, loading and unloading of the laundry into and from the rotary drum becomes rather troublesome and it is highly likely that the laundry would be damaged by contacting the heater protection member directly. Moreover, since no system for controlling the temperature of the hot air from the far infrared radiation heater is provided, the laundry may be damaged due to the excessively high-temperature air blown thereto.

### SUMMARY OF THE INVENTION

It is, therefore, an object of the present invention to provide a washing machine having a drying unit capable for drying laundry at a middle or a low temperature by using far infrared radiation, thereby drying the laundry efficiently while concurrently sterilizing and deodorizing it without causing a damage of fiber.

In accordance with a preferred embodiment of the present invention, there is provided a washing machine equipped with a radiation drying unit including: a rotary drum for accommodating laundry therein; a water tub for accommodating the rotary drum rotatably; a far infrared radiation generator for generating a radiant ray in a far infrared wavelength; a radiation transmission portion for transmitting the radiant ray generated by the far infrared radiation generator to the rotary drum; a radiation controller for controlling an amount of the radiant ray transmitted from the far infrared radiation generator to the rotary drum; and a convection fan for circulating air by rotating in forward and reverse direction depending on an internal temperature of the rotary drum.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic exploded perspective view of a conventional drum type washing machine;

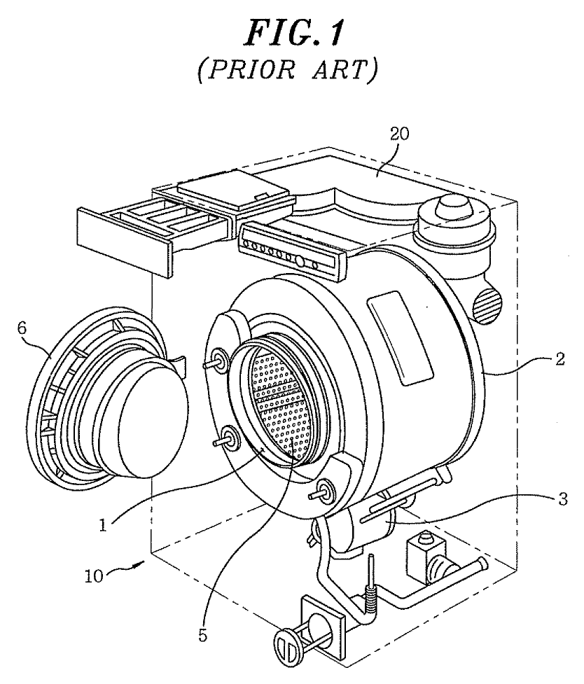

FIG. 2 sets forth a cross sectional view of the conventional drum type washing machine;

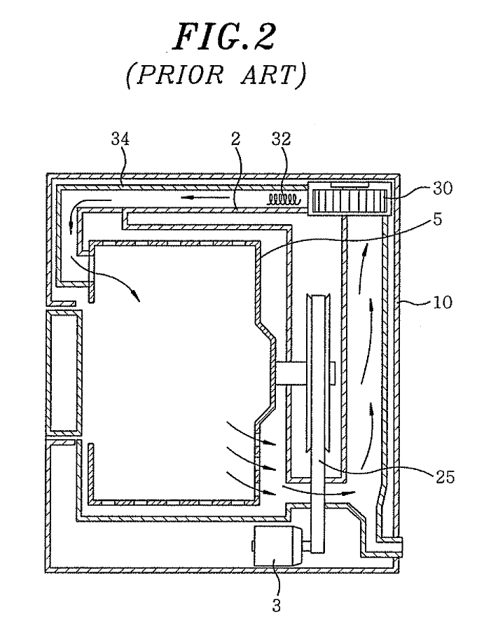

FIG. 3 shows a cross sectional view of another conventional drum type washing machine;

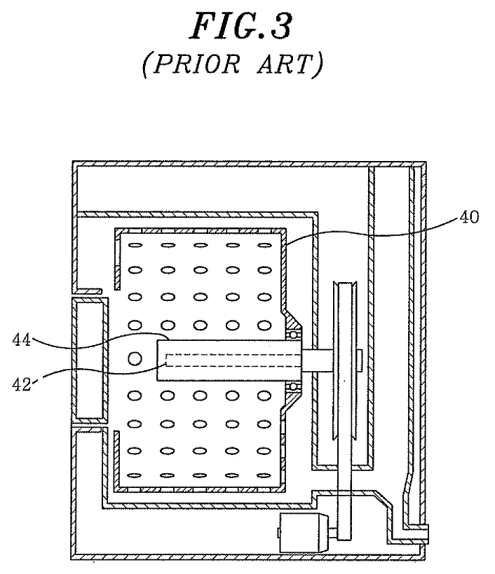

FIG. 4 presents a schematic configuration of a washing machine in accordance with the present invention;

FIGS. 5A and 5B illustrate examples of a radiation drying unit in accordance with the present invention; and

FIG. 6 describes an operational state of a drying function of the washing machine in accordance with the present invention.

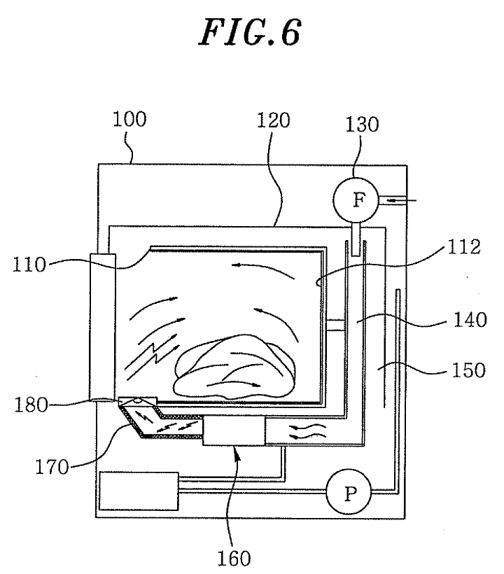

### DETAILED DESCRIPTION OF THE PREFERRED EMBODIMENTS

The technical characteristic of the present invention resides in that it employs a middle or low temperature radiation drying mechanism for drying laundry at a middle or low temperature by using far infrared radiation instead of high-temperature airflow. Specifically, by emitting far infrared rays by means of a heating element and transmitting the far infrared rays to the laundry while controlling their radiation amount, exposure of the laundry to excessively high-temperature air can be avoided, so that the laundry can be dried at the middle or low temperature without being overheated.

Moreover, by installing a convection fan that rotates in forward and reverse direction, it is possible to supply or discharge residual heat, which is generated during the radiation drying process through the far infrared radiation, to the laundry or from the washing machine. As a result, the interior temperature of the rotary drum accommodating therein the laundry can be controlled depending on the drying level of the laundry.

As such, by drying the laundry through the middle or low temperature radiation drying mechanism, the same effect as attained when drying the laundry by natural sunlight can be obtained and, besides, the laundry can be sterilized and deodorized by the far infrared radiations without suffering from damages of fibers.

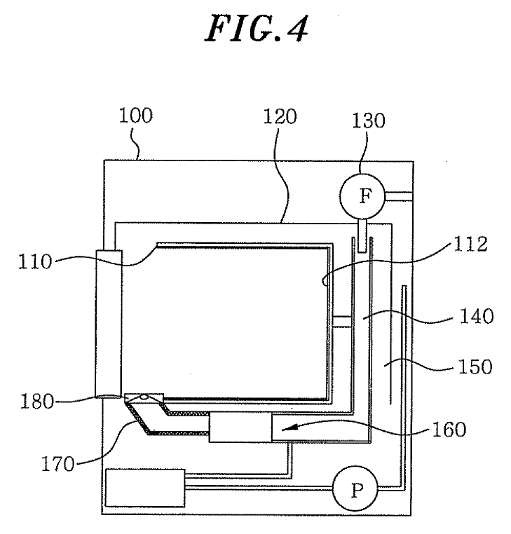

FIG. 4 shows a configuration of a washing machine in accordance with a preferred embodiment of the present invention.

Though a radiation drying unit in accordance with the present invention is shown in FIG. 4 to be applied to a drum type washing machine, it can be applied to drying systems of various types of washing machines including a pulsator type washing machine.

As shown in FIG. 4, a horizontally oriented rotary drum 110 is rotatably installed in a cabinet 100 of the washing machine, and a water tub 120 is also disposed in the cabinet 100 to surround the rotary drum 110.

In addition, a convection fan 130 is further installed in the cabinet 100. The convection fan 130 suctions external air by rotating in forward direction while exhausting air from the rotary drum 110 and the water tub 12 by rotating in reverse direction.

Also, a reflection element 112 is coated on the inner cylindrical surface of the rotary drum 110 to reflect far infrared rays from a far infrared radiation generator 160 to be described later. Further, the drying unit in accordance with the present invention is installed between the outer bottom portion of the rotary drum 110 and the inner bottom portion of the water tub 120. The drying unit communicates with the convection fan 130 via an air flow duct 140 for allowing the external air and circulation air to flow therethrough. Reference numeral 150 is an air outlet for discharging air from the rotary drum 110 and the water tub 120.

Hereinbelow, the configuration of the drying unit connected to the convection fan 130 will be described in further detail. The drying unit includes the far infrared radiation generator 160; a radiation transmission portion 170 for connecting the far infrared radiation generator 160 and the rotary drum 110 to thereby allow them to communicate with each other; and a radiation controller 180 installed at an end side of the radiation transmission portion 170 to control the radiation amount transmitted from the radiation transmission portion 170.

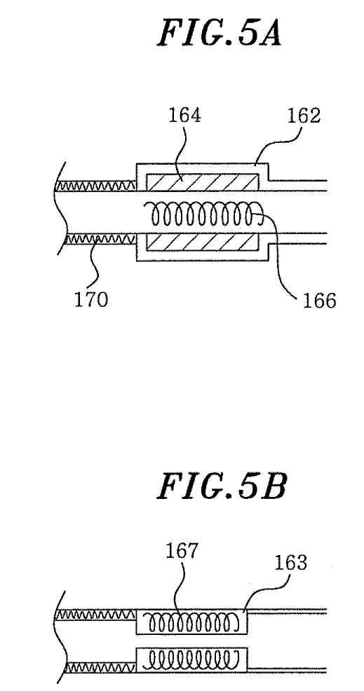

As shown in FIG. 5A, the far infrared radiation generator 160 is activated by a heating element 166 and emits a radiant ray in a far infrared wavelength range. Specifically, the far infrared radiation generator 160 includes a duct-type housing 162 communicating with the radiation transmission portion 170 and the heating element 166 incorporated in the housing 162 while maintaining an interval from the inner surface of the housing 162′. The inner surface of the housing 162 is coated with a far infrared radiation element 164, so that the far infrared ray radiation element 164 is activated by the heating element 166 and the far infrared rays can be radiated.

Alternatively, the housing 162 can be fabricated by an injection molding using a mixture of the far infrared radiation element 164 and a binding material mixed with a predetermined mixture ratio. Preferably, in case of injection molding of the housing 162, the housing 162 can be fabricated by a coating method using 3 wt % of far infrared radiation element 164 and predetermined coating adhesive.

FIG. 5B illustrates a modification of the far infrared radiation generator 160. As shown in the figure, the modified far infrared radiation generator is formed of a casing 163 with a preset thickness and is configured to communicate with the radiation transmission portion 170. Further, a hot wire 167 that emits heat by an external power supply is embedded in the casing 163.

The heating element 166 installed in the housing 162 or the hot wire 167 embedded in the casing 163 are for emitting the far infrared rays and are operated below a conventional heater heating temperature.

Further, the radiation transmission portion 170 transmits the radiant rays through a black body radiation mechanism by completely absorbing the radiant rays and then completely emitting the absorbed radiant rays. The radiation transmission portion 170 is formed as a duct incorporating therein the black body for absorbing and re-emitting the transmitted radiant rays.

More particularly, in order to utilize a principle of complete absorption and complete emission by radiative equilibrium, the duct-type radiation transmission portion 170 is formed to contain a black body material. For example, a black body material capable of carrying out a complete absorption and a complete emission of the radiant rays in the far infrared wavelength range can be coated on the inner surface of the duct-type radiation transmission portion 170.

Accordingly, in case the radiant rays in the far infrared wavelength range emitted from the far infrared radiation generator 160 are eradiated to the radiation transmission portion 170, the radiation transmission portion 170, which is configured as the black body whose inner surface is formed to contain a material with a high albedo (reflectance), can absorb and re-emit the radiant rays without suffering from dispersion or radiation loss. Therefore, the radiant rays emitted from the far infrared radiation generator 160 can be eradiated to the inside of the rotary drum 110 while maintaining the original wavelength range, thereby realizing the radiation drying mechanism.

Further, the radiation controller 180 installed at one end side of the radiation transmission portion 170 adjusts the amount of the radiation to be emitted to the inside of the rotary drum 110. The radiation controller 180 is configured as a shutter made of an opaque radiation absorbent element capable of diminishing or absorbing the radiant rays in the far infrared wavelength range. That is, the control of the radiation amount can be implemented by the camera shutter-like mechanism for controlling the duration of the radiation, while noting that a modification thereof is also possible.

In the drying unit configured as described above, generation of heat during the drying process is performed at a temperature lower than that set to heat wash water, so the laundry can be dried by the middle or low temperature radiation drying mechanism by using far infrared rays generated by the far infrared radiation generator 160.

Hereinafter, the operation of the drying function with the above-descried configuration will be described with reference to FIGS. 5A and 5.

When drying laundry after removing soils from the laundry through washing, rinsing and water-extracting processes performed by the washing machine of the present invention, the heating element 166 incorporated in the far infrared radiation generator 160 is heated to activate the far infrared radiation element 164 installed inside the housing 162, so radiant rays in a far infrared wavelength range are emitted from the far infrared radiation element 164.

The radiant rays are then transmitted via the radiation transmission portion 170 to be eradiated to the laundry accommodated in the rotary drum 110. At this time, the far infrared rays penetrate the laundry by virtue of its penetrating power and penetration depth, thus evaporating the moisture contained in the laundry. As a consequence, the laundry can be dried at a middle or a low temperature without suffering from a rapid and intensive increase of the temperature, as if it were dried by natural sunlight. Particularly, since the inner cylindrical surface of the rotary drum 110 is coated with the far infrared ray reflection element 112, the drying of the laundry can be dried by using the far infrared radiation more effectively.

Moreover, by controlling the radiation amount by means of the radiation controller 180, the overheating of the laundry that might be caused by a continuous exposure to the radiant rays during the drying process can be prevented, so that the laundry can be dried by the far infrared radiations transmitted into the rotary drum 110 at an optimum radiation amount.

Further, the convection fan 130 can be operated to circulate air through the washing machine, to thereby assist the drying process through the far infrared radiation.

The convection fan 130 suctions the external air of the washing machine and directs it into the rotary drum 110 when it rotates in forward direction. The convection fan 130 can be configured to communicate with the far infrared radiation generator 160. This configuration allows some of the residual heat generated by the heating element 166 of the far infrared radiation generator 160 to be transmitted to the inside of the rotary drum 110, thereby improving the drying function. The temperature of the air heated by the residual heat is below a temperature level at which the radiant rays in the far infrared wavelength range heats the laundry, so a supply of excessively high-temperature air to the laundry can be prevented.

Further, in case the laundry is vulnerable to heat and is likely to be damaged if the middle or low temperature air is continuously supplied to the laundry by rotating the convection fan 130, the laundry may get damaged. In order to solve the problems, it is possible to set a reference rotary drum temperature and to stop the convection fan 130 or rotate it in reverse direction to exhaust the hot air from the water tub 120 if the temperature of the rotary drum 110 increases over the reference temperature. For the purpose, a temperature sensor can be additionally installed, e.g., inside the water tub 120 in a vicinity of the end portion of the radiation transmission portion 170.

The above configuration allows a flow of only the middle or low temperature air within the water tub 120. This airflow does not interfere or diminish the radiant rays in the far infrared wavelength, so the middle or low temperature drying process by the radiation can be performed without being affected by the airflow.

As described above, by combining the drying function through the far infrared radiation and the assistant drying function through the middle- or low-temperature airflow, the laundry can be efficiently dried while being sterilized and deodorized by the far infrared rays without suffering from damages of fibers.

In particular, since the laundry is heated at a temperature ranging from 60° C. to 80° C., which is an optimum temperature range for the heating element 166 of the far infrared radiation generator 160 or the hot wire 167 to emit the far infrared rays, an energy loss due to an exothermic loss caused by the conventional drying method of using high-temperature hot air can be reduced considerably.

As described, in accordance with the present invention, the radiant rays in the far infrared wavelength range are radiated to the rotary drum 110 and/or the water tub 120, to thereby sterilize and deodorize the laundry while drying it. As a consequence, the laundry can be efficiently dried without suffering from damages of fibers.

Therefore, the washing machine having the drying unit in accordance with the present invention can perform the radiation drying of the laundry at the middle or low temperature, which is identical to the radiation drying mechanism by the sunlight. Therefore, an energy loss that might be caused by the dry air whose temperature is raised excessively high can be prevented, and various damages of the laundry that might be incurred by the contact with the hot air can also be prevented. Further, by using the far infrared radiations, the laundry can be sterilized and deodorized while it is dried without suffering from damages of fibers. As a consequence, the washing machine with the drying unit of the present invention can be made environment friendly.

While the invention has been shown and described with reference to the preferred embodiments, it will be understood by those skilled in the art that various changes and modifications may be made without departing from the spirit and scope of the invention as defined in the following claims.

1.-13. (canceled)

14. A washing method using a washing machine equipped with a radiation drying unit comprising:
accommodating laundry in a rotary drum, the rotary drum being accommodated rotatably in a water tub;
generating a radiant ray in a far infrared wavelength range by a far infrared radiation generator;
transmitting the radiant ray generated by the far infrared radiation generator to the rotary drum through a radiation transmission portion;
controlling an amount of the radiant ray transmitted from the far infrared radiation generator to the rotary drum by a radiation controller; and
circulating air by rotating in a forward or a reverse direction depending on an internal temperature of the rotary drum using a convention fan,
wherein the convection fan circulates residual heat generated by the heating element for the far infrared radiation generator to the rotary drum by rotating in the forward direction while the convection fan exhausts the air from the rotary drum by rotating in the reverse direction when the internal temperature of the rotary drum exceeds a predetermined temperature level.

15. The washing method of claim 14, wherein the step of generating the radiant ray in the far infrared wavelength range is performed by the far infrared radiation generator which emits far infrared radiation when heated by the heating element.

16. The washing method of claim 14, wherein the far infrared radiation generator includes a duct-type housing communicating with the radiation transmission portion, and the heating element is installed inside the housing while maintaining a predetermined interval from an inner surface of the housing.

17. The washing method of claim 16, wherein an inner surface of the duct-type housing is coated with a far infrared radiation element.

18. The washing method of claim 16, wherein the duct-type housing is fabricated by an injection molding using a mixture of a far infrared radiation element and a binding material mixed at a predetermined mixture ratio.

19. The washing method of claim 14, wherein the far infrared radiation generator includes a casing with a predetermined thickness that communicates with the radiation transmission portion, and a hot wire embedded in the casing, the hot wire being capable of emitting heat by receiving a power from an external power supply.

20. The washing method of claim 19, wherein the casing is fabricated by an injection molding using a mixture of a far infrared radiation element and a binding material.

21. The washing method of claim 14, wherein the step of transmitting the radiant ray includes the step of performing a complete absorption and a complete emission of the radiation by a black body.

22. The washing method of claim 14, wherein the step of controlling the amount of the radiant ray includes absorbing the far infrared radiation transmitted from the radiation transmission portion by an absorbent element.

23. The washing method of claim 14, wherein the radiation transmission portion is of a duct type incorporating therein a black body for absorbing the far infrared radiation transmitted thereto and re-emitting the absorbed far infrared radiation completely.

24. The washing method of claim 14, further comprising detecting an internal temperature of the rotary drum by a temperature sensor.

25. The washing method of claim 14, wherein an inner surface of the rotary drum is coated with a far infrared ray reflection element.
